(19) United States
(12) Patent Application Publication
(10) Pub. No.: US 2006/0224598 A1
(43) Pub. Date: Oct. 5, 2006

(54) Communication device

(76) Inventors: Jeffrey Thielman, Corvallis, OR (US); Kenneth L. Anthony, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/092,066

(22) Filed: Mar. 29, 2005

(51) Int. Cl. G06F 17/00

(52) U.S. Cl. 707/100

(57) ABSTRACT

In one embodiment, a method transmits data between an object and one or more communication devices on a perimeter of a display surface.

### BACKGROUND

A touch screen may be used as an input device to a computer system. For example, a user can touch a portion of the touch screen to indicate a selection. Hence, a touch screen can detect the location of a touch. The current touch screens, however, do not provide the capability for input in other ways to the computer system.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1A illustrates an embodiment of a system for transmitting data between an object and one or more communication devices, according to an embodiment.

FIG. 1B illustrates an embodiment of a display surface with one or more sensors distributed around it to optically communicate with an object, according to an embodiment.

FIG. 2 illustrates sample components of an embodiment of a computing device of FIG. 1A, according to an embodiment.

FIG. 3 illustrates a sample object, according to an embodiment.

FIG. 4 illustrates an embodiment of a method of transmitting data between an object and one or more communication devices, according to an embodiment.

FIG. 5 illustrates various components of an embodiment of a computing device which may be utilized to implement portions of the techniques discussed herein, according to an embodiment.

### DETAILED DESCRIPTION

Various embodiments for transmitting data between an object and one or more communication devices are described. Some of the embodiments are envisioned to provide techniques for transmitting data to/from the object radially without aligning or calibrating the transmitters and/or receivers. In one embodiment, the one or more communication devices are part of a touch screen overlay. The object may be placed on the touch screen overlay to enable data transmission between the object and the one or more communication devices.

Data Transmission System

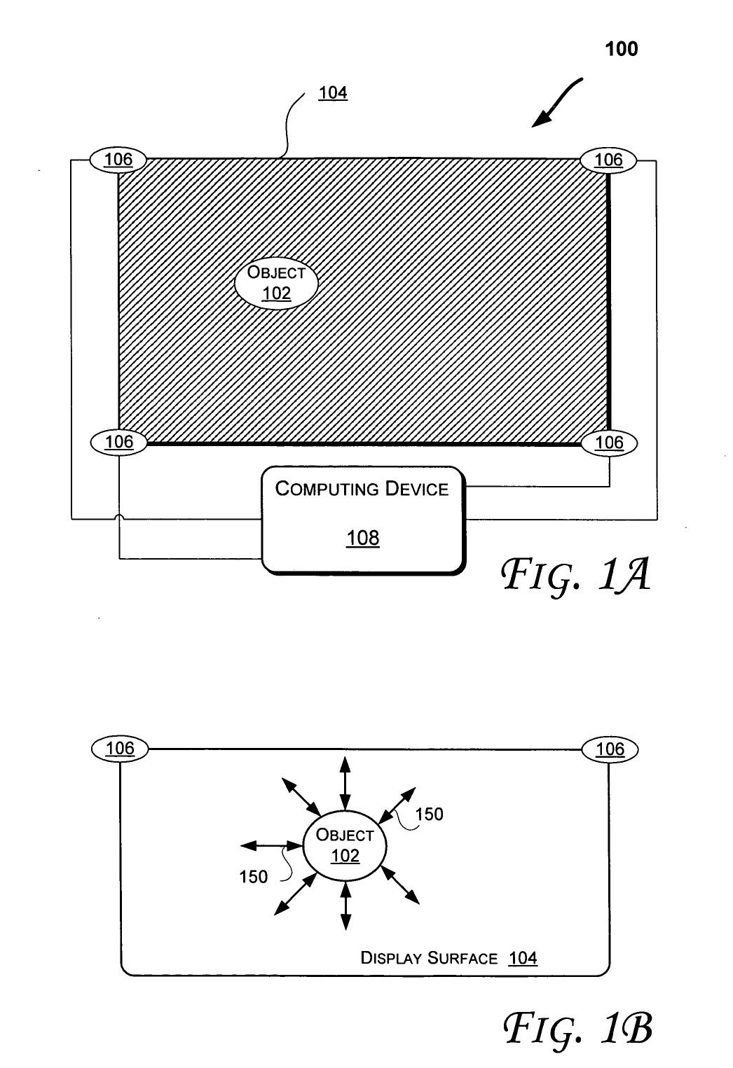

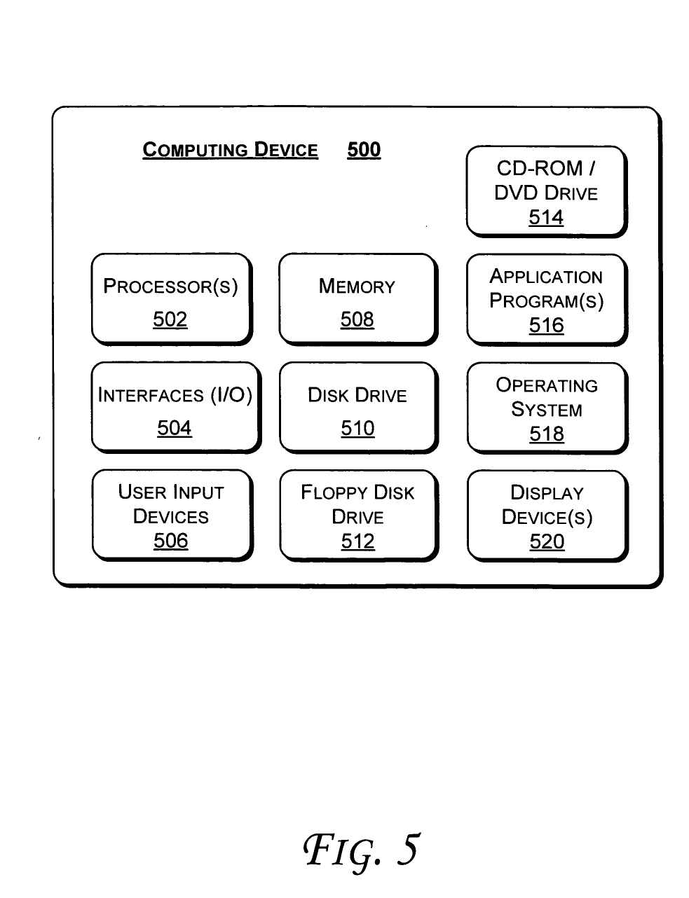

FIG. 1A illustrates an embodiment of a system 100 for transmitting data between an object and one or more communication devices, according to an embodiment. The system 100 includes an object 102 that is proximate to a display surface 104. For example, the object 102 may be placed over or attached to the display surface 104 (e.g., using suction cups, magnets, gravity, and the like). The object 102 may be any suitable object capable of transmitting and/or receiving data such as a computing device (e.g., those discussed with reference to FIG. 5), a token, or a game piece.

The display surface 104 may be a transparent overlay (e.g., a touch screen overlay) that is placed over or attached to a display, such as display device(s) 520 of FIG. 5. In one embodiment, the display surface 104 is provided as a frame, e.g., without any material that may overlay the display device. The display device (and the display surface 104 over it) may be substantially horizontal, for example, a display embedded and/or attached to the top side of a table to enable a plurality of users around the table to interact with the display surface 104. In one embodiment, the display device may be any suitable display device capable of being controlled by a computing device (such as those discussed with respect to FIG. 5), for example, including a rear projection display device, a liquid crystal display device, a cathode ray tube display device, and a plasma display device.

The display surface 104 may be proximate to one or more communication devices 106. The communication devices 106 may be proximate to the perimeter of the display surface 104, and be capable of transmitting and/or receiving data to/from the object 102. Hence, the communication devices 106 may be transmitters and/or receivers. Moreover, even though FIG. 1A illustrates that the communication devices 106 are at the corners of the display surface 104, they may be positioned at any suitable location around the display surface 104 to enable data communication with the object 102. According, the communication devices 106 may be provided as part of a touch screen overlay.

FIG. 1B illustrates an embodiment of a display surface with one or more sensors distributed around it to optically communicate with an object, according to an embodiment. As illustrated by arrows (150) in FIG. 1B, the object (102) may emit optical signals radially that are captured by the communication devices (106). Similarly, the communication devices (106) may emit optical signals that are captured by the object (102). As discussed with reference to FIG. 1A, the optical transmission may be performed by any suitable optical technology.

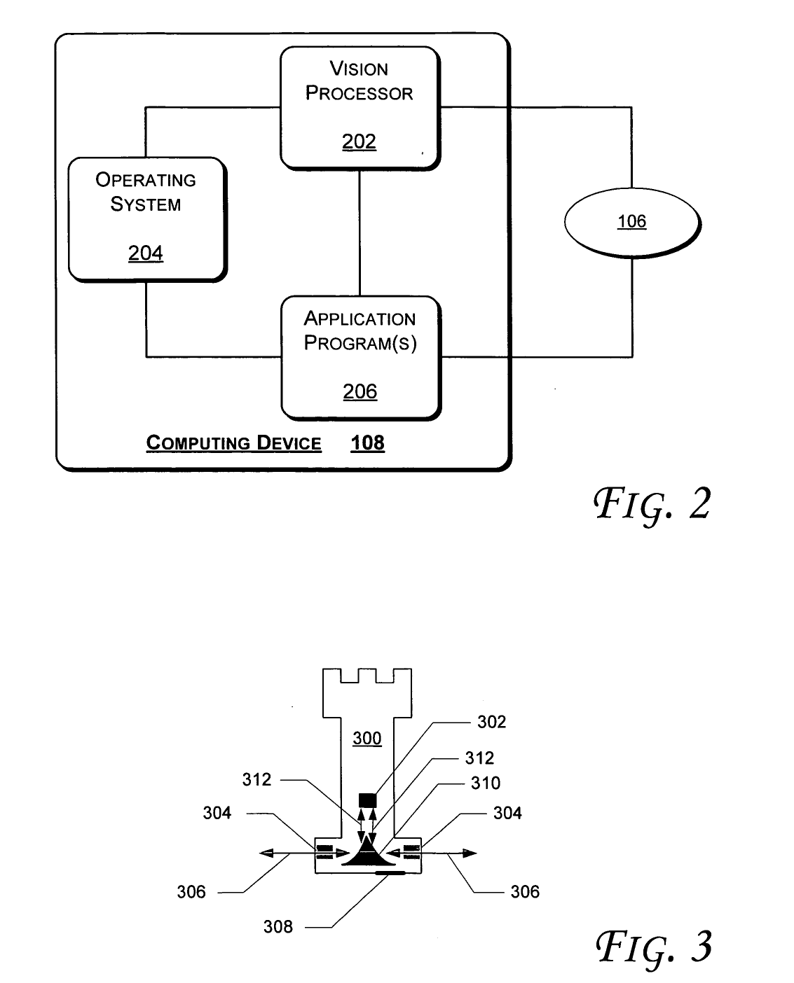

Referring back to FIG. 1A, the communication devices 106 are coupled to a computing device 108 to enable data transmission between the object 102 and the computing device 108, as will be further discussed with reference to FIG. 2. In one embodiment, the data transmission between the object 102 and the one or more communication devices 106 may be performed using optical communication. Also, the transmitted data may be encrypted. The optical transmission may be performed through one or more spectrums of light rays such as visible light and non-visible light rays (i.e. light not readily visible to the unaided human eye, such as ultraviolet and infrared light rays). As receivers, the communication devices 106 may be any suitable optical receiver such as a charge-coupled device (CCD), a complementary metal oxide semiconductor (CMOS) image sensor, an infrared receiver, and/or an infrared Data Association (IrDA) transceiver. Additionally, it is envisioned that broad, narrow, and/or multiple spectrum frequencies may be utilized in various embodiments.

The object 102 may also include a transmitter and/or a receiver (such as those discussed with reference to the communication devices) to enable data transmission between the object 102 and the one or more communication devices. Furthermore, the transmitter of the object 102 may transmit the data radially as will be further discussed with reference to FIG. 3. In one embodiment, the optical transmitters discussed herein may be light-emitting diodes (LEDs).

The transmitted data may include one or more items selected from a group comprising: a unique identifier (ID), an application association, one or more object extents, an object mass, an application-associated capability, a sensor location, a transmitter location, a storage capacity, an object orientation, an object name, an object capability, and/or an object attribute. For example, the object 102 may be capable of providing data regarding its configuration and/or identity to the computing device 108 and the computing device 108 may be capable of transmitting data to the object 102 to modify the configuration of the object 102 or its identity.

FIG. 2 illustrates sample components of an embodiment of a computing device, such as the computing device 108 of FIG. 1A, according to an embodiment. In an embodiment, the computing device 108 may be a general computing device such as computing device 500 discussed with reference to FIG. 5. The computing device 108 includes an embodiment of a processor, such as a vision processor 202 (which may be a general processor(s) such as processor(s) 502 discussed with reference to FIG. 5), coupled to the receivers discussed with reference to FIG. 1A to receive data from the object 102. The vision processor 202 may also receive information about, for example, a change in the number, position, and/or orientation of the objects (102). The vision processor 202 may perform an image comparison (between a reference image of the object 102 over the display surface 104 and a subsequent image) to recognize that the object (102) has changed orientation or position. Accordingly, in one embodiment, the vision processor 202 may perform a frame-to-frame image subtraction to obtain the change or delta of the display surface (104). It is also envisioned that an infrared camera may be utilized to obtain the images.

The vision processor 202 is coupled to an operating system (O/S) 204 and one or more application programs 206. The vision processor 202 may communicate any change to the surface 102 to one or more of the O/S 204 and application programs 206. The application program(s) 206 may utilize the information regarding any changes to cause the communication devices 106 to transmit desired data to the object 102.

For example, if object 102 corresponds to a chess knight that is placed on the surface 104, the application (206) is informed of its identification (ID). If the user places a finger on the knight, the object 102 may transmit a signal to one or more of the communication devices 106 to request that the display device illustrate an image indicating all possible moves, according to the rules, that the knight is able to make on the surface 104. In another example, object 102 corresponds to a “Checker” game piece may include a code. When the piece is “Kinged,” an alignment/interlocking mechanism could be used to request a change to the code so that the application (206) now understands that the piece may move in any direction. The application (206) may further transmit data (e.g., through the communication devices 106) to the object 102 to store this information locally in the object 102. Hence, an object 102 may be moved from one display surface (104) to another display surface (104) while retaining sufficient data to interact with the subsequent display surface (104) and/or computing device (108).

Sample Object

FIG. 3 illustrates a sample object 300, according to an embodiment. The object 300 may be the object 102 discussed with reference to FIGS. 1A and 1B, in one embodiment. The object 300 includes a transmitter 302, e.g., to transmit data to one or more communication devices (such as 106 discussed with reference to FIG. 1A), one or more optional windows 304, e.g., to allow rays (306) from the transmitter 302 to pass through while protecting the transmitter 302 from the elements (such as dust, water, etc.), and a receiver 308, e.g., to receive data from one or more communication devices (such as 106 discussed with reference to FIG. 1A). It is also envisioned that the windows 304 may filter the rays (306) that pass through them (304), e.g., to provide polarized rays and the like.

In an embodiment, the object 300 comprises a mirror (310), such as a cone-shaped mirror, to radially transmit an optical signal (312) generated by the transmitter 302. The mirror 310 may also be utilized to radially receive optical signals (312) by a receiver that is located with the transmitter 302, e.g., in a focal point of the mirror 310. It is envisioned that any suitable mirror or mirrors may be utilized to enable radial communication of optical signals by the object 300. Furthermore, while the receiver 308 is illustrated to be on a bottom side and the transmitter on the interior of the object 300, it is envisioned that the transmitter 302 and the receiver 308 may be positioned at any suitable location to enable data transmission with one or more communication devices (such as communication devices 106 of FIG. 1A). Also, in one embodiment, the transmitter 302 may be positioned directly behind the windows 304 (e.g., without the mirror 310 present).

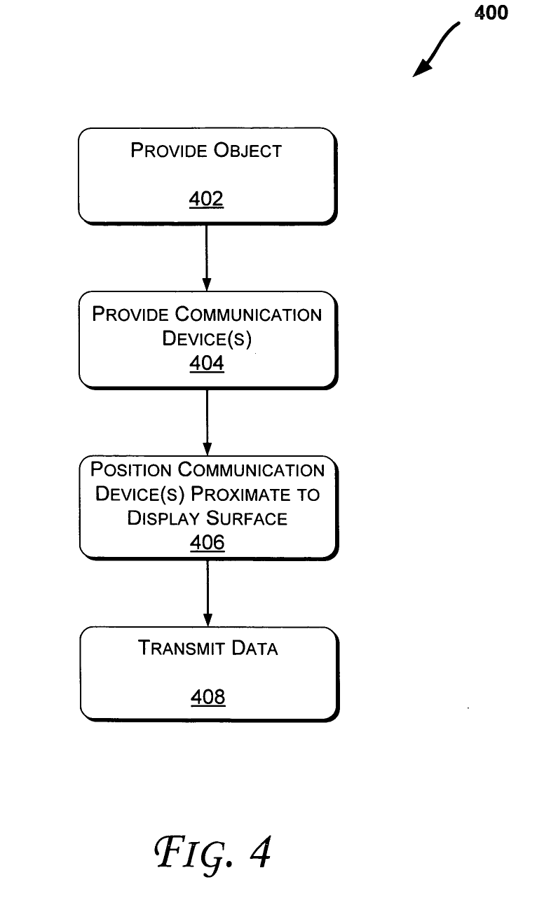

FIG. 4 illustrates a method 400 of transmitting data between an object and one or more communication devices, according to an embodiment. The method 400 provides an object (402) such as the objects 102 and 300 discussed with reference to FIGS. 1A and 3. One or more communication devices are also provided (404), such as 106 of FIG. 1A. The communication devices are positioned proximate to a display surface (406), such as the perimeter of the display surface 104 of FIG. 1A. And, data is transmitted (408) between the object (102, 300) and the one or more communication devices (106) such as discussed with reference to the previous figures.

Exemplary Computing Environment

FIG. 5 illustrates various components of an embodiment of a computing device, such as computing device 500, which may be utilized to implement portions of the techniques discussed herein. In one embodiment, the computing device 500 can be used to perform the method of FIG. 4. The computing device 500 may also be used to provide the computing device 108. The computing device 500 may further be used to manipulate, enhance, and/or store the data discussed herein.

The computing device 500 includes one or more processor(s) 502 (e.g., microprocessors, controllers, etc.), input/output interfaces 504 for the input and/or output of data, and user input devices 506. The processor(s) 502 process various instructions to control the operation of the computing device 500, while the input/output interfaces 504 provide a mechanism for the computing device 500 to communicate with other electronic and computing devices. The user input devices 506 can include a keyboard, touch screen (such as the display surface 104 of FIG. 1A), mouse, pointing device, and/or other mechanisms to interact with, and to input information to the computing device 500.

The computing device 500 may also include a memory 508 (such as read-only memory (ROM) and/or random-access memory (RAM)), a disk drive 510, a floppy disk drive 512, and a compact disk read-only memory (CD-ROM) and/or digital video disk (DVD) drive 514, which may provide data storage mechanisms for the computing device 500.

The computing device 500 also includes one or more application program(s) 516 and an operating system 518 (such as discussed with reference to FIG. 2), which can be stored in non-volatile memory (e.g., the memory 508) and executed on the processor(s) 502 to provide a runtime environment in which the application program(s) 516 can run or execute. The computing device 500 can also include one or more integrated display device(s) 520, such as for a PDA, a portable computing device, and any other mobile computing device.

Select embodiments discussed herein (such as those discussed with reference to FIG. 4) may include various operations. These operations may be performed by hardware components or may be embodied in machine-executable instructions, which may be in turn utilized to cause a general-purpose or special-purpose processor, or logic circuits programmed with the instructions to perform the operations. Alternatively, the operations may be performed by a combination of hardware and software.

Moreover, some embodiments may be provided as computer program products, which may include a machine-readable or computer-readable medium having stored thereon instructions used to program a computer (or other electronic devices) to perform a process discussed herein. The machine-readable medium may include, but is not limited to, floppy diskettes, hard disk, optical disks, CD-ROMs, and magneto-optical disks, ROMs, RAMs, erasable programmable ROMs (EPROMs), electrically EPROMs (EEPROMs), magnetic or optical cards, flash memory, or other suitable types of media or computer-readable media suitable for storing electronic instructions and/or data. Moreover, data discussed herein may be stored in a single database, multiple databases, or otherwise in select forms (such as in a table).

Additionally, some embodiments discussed herein may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method comprising:
transmitting data between an object and one or more communication devices on a perimeter of a display surface.

2. The method of claim 1, further comprising attaching the display surface that is implemented as a touch screen overlay to a display device.

3. The method of claim 1, wherein the object comprises a mirror to radially transmit an optical signal generated by a single optical transmitter.

4. The method of claim 1, wherein the data is transmitted via optical transmission.

5. The method of claim 1, wherein the optical transmission is performed through one or more spectrums of light rays selected from a group comprising visible light and non-visible light rays.

6. The method of claim 1, wherein the transmitted data comprises one or more items selected from a group comprising a unique identifier (ID), an application association, one or more object extents, an object mass, an application-associated capability, a sensor location, a transmitter location, a storage capacity, an object orientation, an object name, an object capability, and an object attribute.

7. The method of claim 1, wherein the transmitted data is encrypted.

8. An apparatus comprising:
an object capable of data transmission; and
one or more communication devices capable of data transmission and located on a perimeter of a display surface.

9. The apparatus of claim 8, wherein at least one of the one or more communication devices is selected from a group comprising a transmitter and a receiver.

10. The apparatus of claim 9, wherein the receiver is selected from a group comprising a charge-coupled device, a complementary metal oxide semiconductor image sensor, an infrared receiver, and an IrDA transceiver.

11. The apparatus of claim 8, wherein the one or more communication devices are provided as part of a touch screen overlay.

12. The apparatus of claim 8, wherein the object comprises a transmitter to transmit the data to the one or more communication devices.

13. The apparatus of claim 8, wherein the object comprises a mirror to radially transmit an optical signal generated by an optical transmitter.

14. The apparatus of claim 8, further comprising one or more transmitters that are light-emitting diodes.

15. The apparatus of claim 8, wherein data is transmitted via optical transmission.

16. The apparatus of claim 8, wherein the transmission is performed via one or more spectrums of light rays selected from a group comprising ultraviolet light and infrared light rays.

17. The apparatus of claim 8, wherein the display surface is substantially horizontal.

18. The apparatus of claim 8, wherein the object is selected from a group comprising a computing device, a token, and a game piece.

19. The apparatus of claim 8, wherein the display surface is provided by a display device selected from a group comprising a rear projection display device, a liquid crystal display device, a cathode ray tube display device, and a plasma display device.

20. The apparatus of claim 8, wherein transmitted data comprises one or more items selected from a group comprising a unique identifier (ID), an application association, one or more object extents, an object mass, an application-associated capability, a sensor location, a transmitter location, a storage capacity, an object orientation, an object name, an object capability, and an object attribute.

21. A system comprising:
a display surface;
one or more communication devices capable of transmitting data and positioned on a perimeter of the display surface; and
an object capable of transmitting data,
wherein data is transmitted between the object and the one or more communication devices.

22. The system of claim 21, wherein the one or more communication devices are provided as part of a touch screen overlay.

23. The system of claim 21, wherein the data is transmitted via optical transmission.

24. A computer-readable medium comprising:
stored instructions to transmit data between an object and one or more communication devices on a perimeter of a display surface.

25. The computer-readable medium of claim 24, further comprising stored instructions to encrypt the data.

26. An apparatus comprising:
means for transmitting data between an object and one or more communication devices,
wherein the one or more communication devices are on a perimeter of a display surface.

27. The apparatus of claim 26, further comprising means for encrypting the data.
